(19) United States
(12) Patent Application Publication
(10) Pub. No.: US 2025/0010241 A1
(43) Pub. Date: Jan. 9, 2025

(54) CO2 GAS REMOVAL DEVICE AND CO2 GAS ABSORBENT PURIFICATION DEVICE USED THEREIN

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Hayato MORIGAKI, Ota Tokyo (JP); Koshito FUJITA, Yokohama Kanagawa (JP); Yasuhiro KATO, Machida Tokyo (JP); Osamu SHIBASAKI, Yokohama Kanagawa (JP); Daigo MURAOKA, Kawasaki Kanagawa (JP); Shinji MURAI, Sagamihara Kanagawa (JP); Noriko TAKADA, Meguro Tokyo (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/762,816

(22) Filed: Jul. 3, 2024

(30) Foreign Application Priority Data
Jul. 4, 2023 (JP) 2023-109926

(51) Int. Cl. B01D 53/96; B01D 53/14; B01D 53/18; B01D 53/62; B01D 53/78; B01D 61/42

(52) U.S. Cl. CPC B01D 53/965; B01D 53/1425; B01D 53/1475; B01D 53/1493; B01D 53/18; B01D 53/62; B01D 53/78; B01D 61/422; B01D 2252/204; B01D 2257/504; B01D 2258/02

(57) ABSTRACT

To provide a CO₂ gas removal device capable of repeatedly using an acid component capture liquid for purifying a CO₂ gas absorbent. A CO₂ gas removal device includes: a CO₂ separation and recovery unit which absorbs and recovers a gas to be treated containing a CO₂ gas by using a CO₂ absorbent containing an amine-based compound; and a CO₂ absorbent purification unit which purifies the CO₂ absorbent from the CO₂ absorbent by electrodialysis, in which the CO₂ absorbent purification unit includes an electrodialysis unit which purifies the CO₂ absorbent by moving an acid component included in the CO₂ absorbent to an acid component capture liquid, an amine separation unit which separates the amine-based compound from the acid component capture liquid, and an acid component separation unit which separates the acid component from the acid component capture liquid.

### CROSS REFERENCE TO RELATED APPLICATIONS

This application is based upon and claims the benefit of priority from the prior Japanese Patent Application 2023-109926, filed on Jul. 4, 2023, the entire contents of which are incorporated herein by reference.

### FIELD

Embodiments of the present invention relate to a CO₂ gas removal device for removing CO₂ gas included in exhaust gas emitted from a factory or the like, and a CO₂ gas absorbent purification device capable of purifying a CO₂ absorbent used in the device.

### BACKGROUND

To achieve the “2° C. target” and the “1.5° C. effort target” relating to the suppression of temperature rises stipulated in the Paris Agreement, each country is required to further accelerate climate change countermeasures. Here, carbon dioxide capture, utilization and storage (CCUS) is expected to play a large role together with hydrogen, renewable energy, and the like as a measure for reducing the large emission amount of carbon dioxide (CO₂) causing a greenhouse effect.

One of methods for recovering CO₂ is a chemical absorption method. In the chemical absorption method, a CO₂-containing exhaust gas emitted from a thermal power plant, a steel mill, or the like is brought into contact with an aqueous solution (hereinafter, the liquid may be referred to as an absorbent) including a basic compound such as an amino group-containing compound (hereinafter, the compound may be referred to as an amine-based compound) to absorb CO₂ into the absorbent. In the chemical absorption method, CO₂ is recovered by repeatedly circulating the absorbent between an absorption unit which absorbs CO₂ into the absorbent and a regeneration unit which releases CO₂ from the absorbent. However, when CO₂ is absorbed, acid components other than CO₂ are also absorbed into the absorbent. The acid components, for example, NOx and SOx, such as carbonyl sulfide, hydrogen cyanide, thiocyanic acid, and thiosulfuric acid, react with the amine-based compound in the absorbent to generate impurities called heat stable amine salt (HSAS). In addition, the amine-based compound may be decomposed or modified due to heating performed to release CO₂ in a recovery unit or the reaction between oxygen in the exhaust gas and the amine-based compound, and the generation of the heat stable amine salt may be promoted. When the thermally stable amine salt is accumulated in the absorbent, not only the CO₂ absorption efficiency of the absorbent is decreased but also corrosion of the CO₂ recovery device may be caused, and thus it is desired to remove the heat stable amine salt from the absorbent and to suppress generation of the heat stable amine salt.

An electrodialysis method is one of techniques for removing an acid component which can configure a heat stable amine salt. In the electrodialysis method, an ion exchange unit in which ion exchange membranes are stacked is sandwiched between electrodes from both ends, and a voltage is applied. Here, the absorbent and the acid component capture liquid (hereinafter, the liquid may be referred to as a capture liquid) are brought into contact with each other via an ion exchange membrane or the like, and the acid component in the absorbent is moved to the capture liquid, that is, the acid component is removed from the absorbent. In such system, it is desirable to efficiently remove the acid component in the absorbent and to suppress leakage of the amine-based compound into the capture liquid. Meanwhile, by removing the acid component from the absorbent, the acid component accumulates in the capture liquid. When the acid component concentration of the capture liquid exceeds a certain level, the removal efficiency of the acid component from the absorbent decreases. Therefore, it is required to appropriately maintain the acid concentration by periodically replacing or diluting the capture liquid, but as a result, there is a problem that a large amount of waste liquid of the capture liquid is generated.

### BRIEF DESCRIPTION OF THE DRAWINGS

FIG. 1 is a conceptual diagram of a CO₂ gas removal device according to a first embodiment;

FIG. 2 is a conceptual diagram of a CO₂ gas removal device according to a second embodiment;

FIG. 3 is a conceptual diagram of a CO₂ gas removal device according to a third embodiment;

FIG. 4 is a conceptual diagram of a CO₂ gas removal device according to a fourth embodiment;

FIG. 5 is a conceptual diagram of a CO₂ gas removal device according to a fifth embodiment; and

FIG. 6 is a conceptual diagram of a CO₂ gas removal device according to a sixth embodiment.

### DETAILED DESCRIPTION

A CO₂ gas removal device according to the present embodiment includes:
a CO₂ separation and recovery unit which brings a gas to be treated containing a CO₂ gas into contact with a CO₂ absorbent containing an amine-based compound to absorb the CO₂ gas, further recovers the CO₂ gas from the CO₂ absorbent which absorbed the CO₂ gas, regenerates the CO₂ absorbent, and reuses the regenerated CO₂ absorbent as the CO₂ absorbent; and
a CO₂ absorbent purification unit which removes an acid component from the CO₂ absorbent by electrodialysis to purify the CO₂ absorbent,
in which the CO₂ absorbent purification unit includes
an electrodialysis unit which includes, between a pair of electrodes facing each other, a desalination chamber, a concentration chamber, and a membrane disposed between the desalination chamber and the concentration chamber and selected from a cation exchange membrane, an anion exchange membrane, or a bipolar membrane and purifies the CO₂ absorbent by eluting the acid component from the CO₂ absorbent introduced into the desalination chamber to an acid component capture liquid introduced into the concentration chamber,
an amine separation unit which separates an amine-based compound included in the acid component capture liquid, and
an acid component separation unit which separates an acid component included in the acid component capture liquid, and
the electrodialysis unit, the amine separation unit, and the acid component separation unit are coupled so that the acid component capture liquid can circulate.

Also, a CO₂ absorbent purification unit according to the present embodiment includes:
an electrodialysis unit which includes, between a pair of electrodes facing each other, a desalination chamber, a concentration chamber, and a membrane disposed between the desalination chamber and the concentration chamber and selected from a cation exchange membrane, an anion exchange membrane, or a bipolar membrane and purifies the CO₂ absorbent by eluting the acid component from the CO₂ absorbent introduced into the desalination chamber and including the acid component to an acid component capture liquid introduced into the concentration chamber; and
an amine separation unit which separates an amine-based compound included in the acid component capture liquid; and
an acid component separation unit which separates an acid component included in the acid component capture liquid,
in which the electrodialysis unit, the amine separation unit, and the acid component separation unit are coupled so that the acid component capture liquid can circulate.

Also, in a CO₂ gas removal method according to the present embodiment, a gas to be treated containing a CO₂ gas is brought into contact with a CO₂ absorbent containing an amine-based compound to absorb the CO₂ gas, the CO₂ gas is recovered from the CO₂ absorbent which absorbed the CO₂ gas, the CO₂ absorbent is regenerated, and the regenerated CO₂ absorbent is reused as the CO₂ absorbent, the method including:
purifying the CO₂ absorbent by moving an acid component to an acid component capture liquid by electrodialysis;
separating an amine-based compound included in the acid component capture liquid; and
separating the acid component included in the acid component capture liquid.

According to the present embodiment, the acid component capture liquid for purifying the CO₂ gas absorbent used in the CO₂ gas removal device can be repeatedly used, and the amount of acid waste liquid can be reduced.

Hereinafter, embodiments for carrying out the invention are described.

### First Embodiment

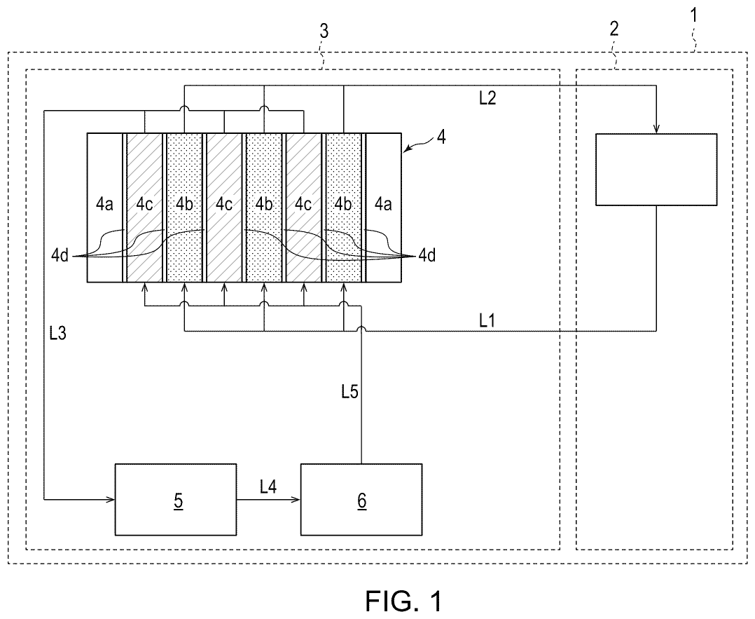

FIG. 1 is a conceptual diagram of a CO₂ gas removal device according to a first embodiment. As illustrated in FIG. 1, a CO₂ gas removal device 1 according to the embodiment includes a CO₂ separation and recovery unit 2 and a CO₂ absorbent purification unit 3.

The CO₂ separation and recovery unit 2 brings a gas to be treated containing a CO₂ gas into contact with an absorbent containing an amine-based compound in an absorption unit to absorb the CO₂ gas, further recovers the CO₂ gas from the absorbent which absorbed the CO₂ gas in a regeneration unit, regenerates the absorbent, and reuses the regenerated absorbent as the CO₂ absorbent. Therefore, the absorbent is circulated between the absorption unit and the regeneration unit (both not illustrated) included in the CO₂ separation and recovery unit. Such a CO₂ separation and recovery unit 2 can be arbitrarily selected from generally known CO₂ separation and recovery units and used.

The CO₂ absorbent purification unit 3 removes an acid component from the absorbent emitted from the CO₂ separation and recovery unit 2 to purify the absorbent and releases a part of the generated absorbent to the CO₂ separation and recovery unit 2. That is, a part of the absorbent circulating in the CO₂ separation and recovery unit 2 flows into the CO₂ absorbent purification unit 3 through an absorbent introduction line L1, and the purified absorbent flows out to the CO₂ separation and recovery unit 2 through an absorbent emission line L2. As a result, the CO₂ separation and recovery unit 2 and the CO₂ absorbent purification unit 3 are connected so that the circulation liquid circulates therebetween.

The CO₂ absorbent purification unit 3 includes an electrodialysis unit 4, an amine separation unit 5, and an acid component capture liquid separation unit 6.

The electrodialysis unit 4 includes a pair of opposing electrodes 4a and includes desalination chambers 4b and concentration chambers 4c therebetween. Membranes 4d selected from a cation exchange membrane, an anion exchange membrane, or a bipolar membrane are arranged between the desalination chambers 4b and the concentration chambers 4c, and the absorbent introduced into the desalination chamber and the acid component capture liquid introduced into the concentration chamber can be indirectly brought into contact with each other.

FIG. 1 illustrates the electrodialysis unit including three desalination chambers and three concentration chambers, but only one or more desalination chambers and one or more concentration chambers needs to be arranged, and two or four or more desalination chambers and concentration chambers may be arranged.

In the embodiment, a part or all of the absorbent circulating in the CO₂ separation and recovery unit 2 is supplied to the CO₂ absorbent purification unit 3 via the absorbent introduction line L1.

In the CO₂ separation and recovery unit, a gas containing CO₂ (gas to be treated) is brought into contact with an absorbent to take CO₂ into the absorbent. Examples of the gas to be treated include combustion exhaust gas emitted from a heater or a gas turbine of a thermal power plant or the like, process exhaust gas generated in a steel plant, and combustion exhaust gas generated in a cleaning plant. The gas to be treated is preferably cooled by a cooler or the like, subjected to a treatment such as desulfurization or denitration, and then supplied to the CO₂ separation and recovery unit. By performing a desulfurization or denitration treatment on the gas to be treated, the formation of heat stable amine salt in the absorbent can be suppressed, and the load on the CO₂ absorbent purification unit 3 can be reduced.

The absorbent generates a carbonate when absorbing CO₂ in the gas to be treated (Formula (1)). At the same time, SOx, NOx, carbonyl sulfide, hydrogen cyanide, thiocyanate, thiosulfuric acid, other inorganic acids, and the like included in the gas to be treated are also absorbed, whereby a heat stable amine salt is generated (Formula (2)). Here, oxygen included in the gas to be treated may react with a component of the absorbent to generate an organic acid, for example, formic acid or acetic acid in the absorbent, and the organic acid may react with an amine-based compound to form a heat stable amine salt.

R₃N+CO₂+H₂O→R₃NH₂CO₃ (1)

R₃N+HX→R₃NHX (2)

Here, R represents hydrogen, a substituted or unsubstituted alkyl group (which may form a heterocyclic ring), or the like, and HX is an acid component capable of forming a heat stable amine salt such as sulfuric acid or nitric acid. In the present embodiment, the acid component refers to an acid compound capable of forming a heat stable amine salt other than CO₂ or carbonic acid.

The absorbent is preferably an aqueous solution including an amine-based compound and water. Examples of the preferable amine-based compound include
(i) primary amines such as monoethanolamine and 2-amino-2-methyl-1-propanol,
(ii) secondary amines such as diethanolamine and 2-methylaminoethanol,
(iii) tertiary amines such as triethanolamine and N-methyldiethanolamine,
(iv) polyethylene polyamines such as ethylenediamine, triethylenediamine, and diethylenetriamine,
(v) cyclic amines such as piperazines, piperidines, and pyrrolidines,
(vi) polyamines such as xylylenediamine, and
(vii) amino acids such as methylaminocarboxylic acid, and the compounds can be used singly or in combination of two or more kinds thereof.

The absorbent is usually used as an aqueous solution including 10 to 70 wt % of the amine-based compounds. In addition, the absorbent can appropriately contain other compounds such as a reaction accelerator, a nitrogen-containing compound which improves the absorption performance of an acidic gas such as CO₂, an anticorrosive agent for preventing corrosion of plant facilities, an antifoaming agent for preventing foaming, an antioxidant for preventing deterioration of the absorbent, and a pH adjuster in an arbitrary ratio, as necessary, as long as the effect of the absorbent is not impaired.

In the absorbent which absorbed the CO₂ gas, the absorbed CO₂ is separated from the absorbent in a regenerator or the like generally arranged in the CO₂ separation and recovery unit and is further purified by an electrodialysis unit according to the embodiment to be repeatedly used. However, since the generated heat stable amine salt is not removed by a general CO₂ separation and recovery unit, the heat stable amine salt tends to accumulate in the absorbent.

In the present embodiment, a part or all of the absorbent can be purified by performing an electrodialysis treatment in the CO₂ absorbent purification unit 3 and removing the heat stable amine salt. The absorbent from which the acid component has been removed by the electrodialysis unit 4 is returned to the CO₂ separation and recovery unit again via the absorbent emission line L2.

In the first embodiment, the CO₂ absorbent purification unit 3 includes the electrodialysis unit 4, the amine separation unit 5, and the acid component separation unit 6. The capture liquid flows between the devices by a pump (not illustrated) disposed at an arbitrary position. The absorbent is supplied from the absorbent introduction line L1 to the electrodialysis unit 4, the capture liquid is supplied from the capture liquid introduction line L5 to the electrodialysis unit 4, and a voltage is applied to the electrodes 4a at both ends of the electrodialysis unit 4, so that the acid component of the heat stable amine salt in the absorbent can be removed. The electrodialysis unit includes, for example, an anode and a cathode at both ends, and the membrane 4d such as a cation exchange membrane, an anion exchange membrane, or a bipolar membrane is disposed between the desalination chamber 4b and the concentration chamber 4c.

As the cation exchange membrane, a polymer membrane having a cation exchange group capable of passing cations and blocking passage of anions is used. For example, a membrane made of a polymer having one or more sulfonic acid groups, carboxylic acid groups, phosphonic acid groups, sulfuric acid ester groups, and phosphoric acid ester groups can be used. Specifically, well-known cation exchange membranes such as NEOSEPTA CMX and NEOSEPTA CMB (merchandise name, manufactured by ASTOM Corporation) SELEMION CMV, SELEMION CMD, SELEMION CSO, and SELEMION CMF (merchandise name, manufactured by AGC Engineering Co., Ltd.) can be used as a preferable cation exchange membrane.

As the anion exchange membrane, a polymer membrane having an anion exchange group capable of passing anions and blocking the passage of cations is used. For example, a film made of a polymer having a weakly basic functional group such as a primary amino group, a secondary amino group, or a tertiary amino group in a strongly basic group of a quaternary ammonium group can be used. Specifically, well-known anion exchange membranes such as NEOSEPTA AMX and NEOSEPTA AHA (merchandise name, manufactured by ASTOM Corporation); SELEMION AMV, SELEMION AMT, SELEMION DSV, SELEMION ASV, and SELEMION AHO (merchandise name, manufactured by AGC Engineering Co., Ltd.) can be used as a preferable anion exchange membrane.

The bipolar membrane is a composite membrane in which an anion exchange membrane and a cation exchange membrane are laminated and is disposed such that an anode side is an anion exchange membrane and a cathode side is a cation exchange membrane. When a voltage is applied at the theoretical decomposition voltage of water or more in the existence of water, water can be electrolyzed into hydrogen ions and hydroxide ions. Specifically, a well-known bipolar membrane such as NEOSEPTA BP-1E (merchandise name, manufactured by ASTOM Corporation) can be used as the preferable bipolar membrane.

The capture liquid only needs to be an electrodialyzable aqueous solution having electric resistance, and it is more preferable that the capture liquid contains a small amount of an acid component at the initial stage of operation, because the amount of amine which can exist as a cation when moving to the capture liquid increases, and thus the recovered amount of amine increases. As the acid component, for example, sulfuric acid, nitric acid, formic acid, acetic acid, or the like can be used. In addition, when the capture liquid is circulated and used, the acid component removed from the absorbent is accumulated, and thus it is preferable to add the acid component to the capture liquid only at the initial stage of operation and not to add the acid component thereafter in the operation, because generation of an unnecessary heat stable amine salt can be suppressed, and the amount of the acid component to be added can be reduced.

The capture liquid released from the electrodialysis unit 4 is supplied to the amine separation unit 5 via an acid component capture liquid emission line L3. The amine separation unit 5 has a function of mainly separating an amine-based compound from the components included in the capture liquid. The method for separating the amine-based compound is not particularly limited, but reverse osmosis, ultrafiltration, electrodialysis, ion exchange resin, and the like can be used.

The capture liquid from which the amine-based compound is separated in the amine separation unit 5 is supplied to the acid component separation unit 6 via the connection line L4. The acid component separation unit 6 has a function of mainly separating an acid component from the components included in the capture liquid.

The method for removing the acid component from the capture liquid is not particularly limited, and a method of forming a salt having the acid component as a base and removing the neutralized salt can be adopted. For example, by adding an alkali compound having an alkali metal or an alkaline earth metal as a cation to the capture liquid, an acid component and a neutralized salt in the capture liquid can be generated. By removing the neutralized salt, the acid component can be removed from the capture liquid. The injection of the alkali compound can be performed manually, but an alkali compound injection unit can be further provided in the CO₂ removal device.

As a method for removing the generated neutralized salt, the alkali compound is added, and then the mixture is cooled to a low temperature, for example, 0° C. or lower, so that the solubility of the neutralized salt can be decreased to precipitate the neutralized salt. Specific preferable examples of the alkali compound which can be added include KOH, NaOH, Ca(OH)₂, and Mg(OH)₂. As the acid component in the capture liquid, there may be a plurality of kinds of inorganic acid derived from exhaust gas and organic acid derived from amine-based compounds, and thus it is desirable to select an alkali compound to be added according to the existing acid component. For example, when the neutralized salt is potassium nitrate or sodium formate, the solubility thereof and the soluble concentration in water determined from the solubility are as shown in Table 1.

TABLE 1

| Compound | | 0° C. | 10° C. | 20° C. | 30° C. |
|---|---|---|---|---|---|
| KNO3 | Solubility in water [g/100 g of water] | 13.9 | 21.9 | 31.6 | 45.3 |
| | Soluble concentration in water [mol/L] | 1.38 | 2.17 | 3.13 | 4.48 |
| (COONa)2 | Solubility in water [g/100 g of water] | 2.69 | 3.05 | 3.41 | 3.81 |
| | Soluble concentration in water [mol/L] | 0.2 | 0.23 | 0.25 | 0.28 |

The capture liquid generated by removing the acid component in the acid component separation unit 6 is introduced into the electrodialysis unit 4 via an acid component capture liquid introduction line L5 and reused for removing the acid component.

### Second Embodiment

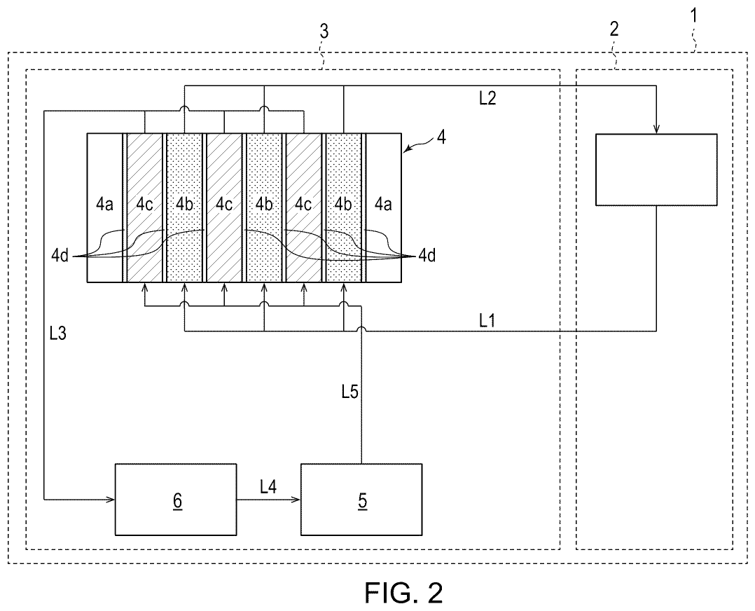

FIG. 2 is a conceptual diagram of a CO₂ gas removal device according to a second embodiment. The main difference between the present embodiment and the first embodiment is the order of the amine separation unit 5 and the acid component capture liquid separation unit 6.

In the present embodiment, the absorbent is fed from the electrodialysis unit 4 to the acid component separation unit 6 to separate the acid, and then the amine-based compound is separated by the amine separation unit 5. The present embodiment is preferably adopted when the amine compound can be efficiently removed when the concentration of the acid component is decreased in advance in the method for separating an amine-based compound performed by the amine separation unit.

### Third Embodiment

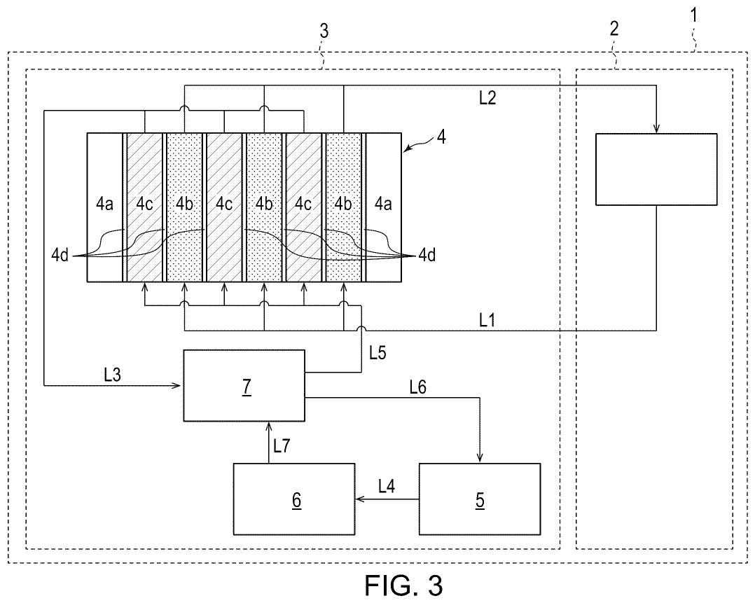

FIG. 3 is a conceptual diagram of a CO₂ gas removal device according to a third embodiment. The main difference between the present embodiment and the first embodiment is that an acid component capture liquid storage tank 7 is provided. The electrodialysis unit 4 and the acid component capture liquid storage tank 7 are connected by the acid component capture liquid emission line L3 and the acid component capture liquid introduction line L5. The capture liquid is circulated between the electrodialysis unit 4 and the acid component capture liquid storage tank 7, and the acid component is moved to the capture liquid in the electrodialysis unit 4, so that the acid component concentration in the capture liquid increases. Meanwhile, the acid component capture liquid storage tank 7, the amine separation unit 5, and the acid component separation unit 6 are connected by an unpurified acid component capture liquid release line L6, the connection line L4, and the purified acid component capture liquid introduction line L7, and a part of the capture liquid stored in the acid component capture liquid storage tank 7 circulates therebetween. The capture liquid circulating in the electrodialysis unit 4 and the capture liquid circulating in the amine separation unit 5 and the acid component separation unit 6 can be circulated at independent flow rates. Therefore, the CO₂ gas removal device of the present embodiment is easier to use than the first or second embodiment which does not include the acid component capture liquid storage tank 7. For example, when a neutralized salt is formed and cooled to generate a precipitate in the acid component separation unit, the circulation of the capture liquid can be stopped during cooling to cool the accumulated capture liquid. In addition, while the acid component concentration, the amine compound concentration, and the like of the circulating capture liquid are measured, the flow rate of the capture liquid circulating in the electrodialysis unit and the flow rate of the capture liquid circulating in the amine separation unit 5 and the acid component separation unit 6 can be independently adjusted so as to optimally purify the absorbent.

### Fourth Embodiment

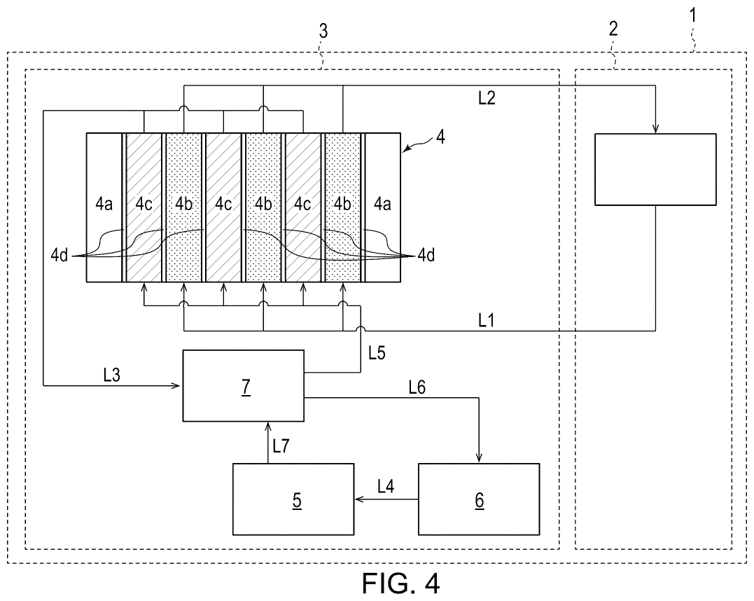

FIG. 4 is a conceptual diagram of a CO₂ gas removal device according to a fourth embodiment. The main difference between the present embodiment and the first embodiment is that the order of the amine separation unit 5 and the acid component capture liquid separation unit 6 is reversed. Similarly to the second embodiment, the present embodiment is preferably adopted when the amine compound can be efficiently removed when the concentration of the acid component is low in the method for separating an amine-based compound performed by the amine separation unit.

### Fifth Embodiment

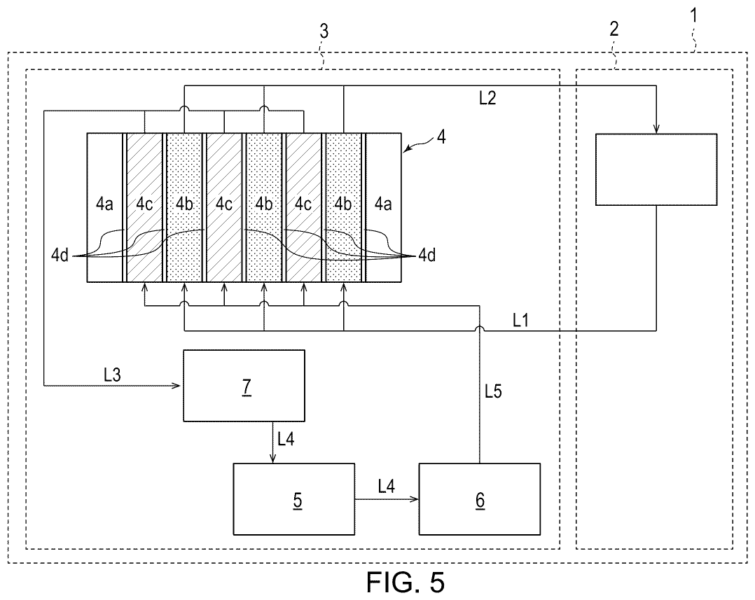

FIG. 5 is a conceptual diagram of a CO₂ gas removal device according to a fifth embodiment. The main difference between the present embodiment and the first embodiment is that the acid component capture liquid storage tank 7 is provided in series with the amine separation unit 5 and the acid component capture liquid separation unit 6. In such a configuration, the flow rate of the circulating capture liquid can be adjusted by increasing or decreasing the capture liquid stored in the acid component capture liquid storage tank. In the method, the range of flow rate adjustment of the capture liquid is reduced, but the configuration of the device can be simplified as compared with the third or fourth embodiment. In the present embodiment, the liquid can be directly fed from the acid component capture liquid separation unit to the electrodialysis unit. In addition, since the capture liquid after separating the acid component is supplied to the electrodialysis unit, improvement in the removal efficiency of the acid component in the electrodialysis unit can be expected.

In the fifth embodiment, the order of connection of the amine separation unit 5, the acid component capture liquid separation unit 6, and the acid component capture liquid storage tank 7 is not particularly limited, and the amine separation unit 5, the acid component capture liquid separation unit 6, and the acid component capture liquid storage tank 7 can be connected in any order.

### Sixth Embodiment

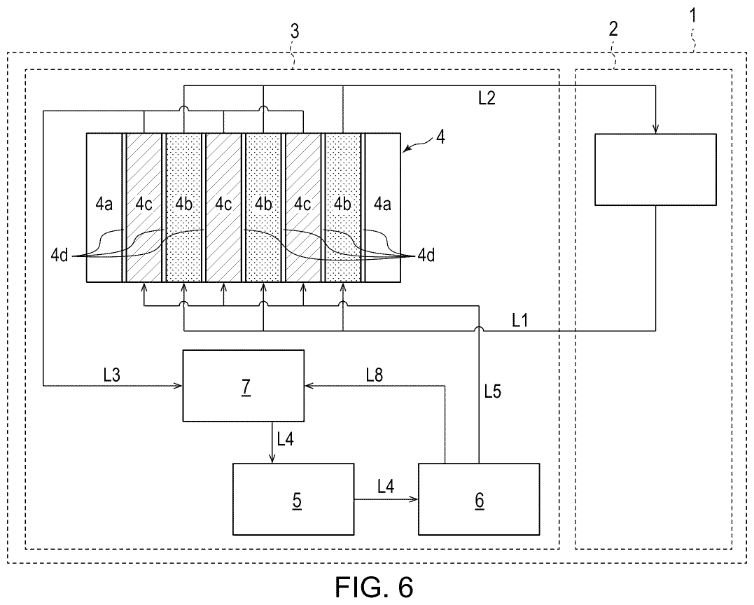

FIG. 6 is a conceptual diagram of a CO₂ gas removal device according to a sixth embodiment. The present embodiment is different from the fifth embodiment in that a once purified capture liquid is circulated in the acid component capture liquid storage tank 7 by a purified acid component capture liquid circulation line. According to such a configuration, the purified capture liquid including less acid components and amine-based compounds can be introduced into the electrodialysis unit, and the flow rate of the capture liquid can be easily adjusted. The flow rate of the capture liquid can be more easily adjusted by providing a bypass for introducing the capture liquid from the acid component capture liquid storage tank 7 to the acid component capture liquid introduction line L5 or the electrodialysis unit 4.

Although the CO₂ gas removal device and the removal method according to some embodiments of the present invention are described above, the embodiments are presented as examples and do not limit the scope of the invention. The embodiments can be realized in various other modes, and various omissions, substitutions, changes, and addition can be made without departing from the gist of the invention. The embodiments and modifications thereof are included in the scope and gist of the invention and are included in the invention described in the claims and the equivalent scope thereof.

### REFERENCE SIGNS LIST

1 CO₂ gas removal device
2 CO₂ separation and recovery unit
3 CO₂ absorbent purification unit
4 electrodialysis unit
4a electrode
4b desalination chamber
4c concentration chamber
4d membrane
5 amine separation unit
6 acid component separation unit
7 acid component capture liquid storage tank
L1 absorbent introduction line
L2 absorbent emission line
L3 acid component capture liquid emission line
L4 connection line
L5 acid component capture liquid introduction line
L6 unpurified acid component capture liquid release line
L7 purified acid component capture liquid introduction line
L8 purified acid component capture liquid circulation line

1. A CO₂ gas removal device comprising:
a CO₂ separation and recovery unit which brings a gas to be treated containing a CO₂ gas into contact with a CO₂ absorbent containing an amine-based compound to absorb the CO₂ gas, further recovers the CO₂ gas from the CO₂ absorbent which absorbed the CO₂ gas, regenerates the CO₂ absorbent, and reuses the CO₂ absorbent as the CO₂ absorbent; and
a CO₂ absorbent purification unit which removes an acid component from the CO₂ absorbent by electrodialysis to purify the CO₂ absorbent,
wherein the CO₂ absorbent purification unit includes
an electrodialysis unit which includes, between a pair of electrodes facing each other, a desalination chamber, a concentration chamber, and a membrane disposed between the desalination chamber and the concentration chamber and selected from a cation exchange membrane, an anion exchange membrane, or a bipolar membrane and purifies the CO₂ absorbent by eluting the acid component from the CO₂ absorbent introduced into the desalination chamber to an acid component capture liquid introduced into the concentration chamber,
an amine separation unit which separates an amine-based compound included in the acid component capture liquid, and
an acid component separation unit which separates an acid component included in the acid component capture liquid, and
the electrodialysis unit, the amine separation unit, and the acid component separation unit are coupled so that the acid component capture liquid can circulate.

2. The CO₂ gas removal device according to claim 1, further comprising an acid component capture liquid storage tank which temporarily stores the acid component capture liquid.

3. The CO₂ gas removal device according to claim 1, wherein the acid component separation unit includes an alkali compound injection unit which injects an alkali compound including alkali metal or alkaline earth metal as a cation to the acid component capture liquid.

4. The CO₂ gas removal device according to claim 3, wherein the acid component separation unit further includes a cooling unit which cools the acid component capture liquid to which the alkali compound is injected.

5. The CO₂ gas removal device according to claim 4, further comprising an acid component recovery unit which separates and recovers the neutralized salt precipitated by being cooled by the cooling unit.

6. The CO₂ gas removal device according to claim 1, wherein the amine separation unit separates the amine-based compound from the acid component capture liquid by reverse osmosis, forward osmosis, ultrafiltration, ion exchange resin, or electrodialysis.

7. The CO₂ gas removal device according to claim 2, wherein a part of the acid component capture liquid circulates from the acid component capture liquid storage tank to the acid component capture liquid storage tank via the electrodialysis unit, and another part of the acid component capture liquid is circulated to the acid component capture liquid storage tank via the amine separation unit and the acid component separation unit.

8. The CO₂ gas removal device according to claim 2, wherein the acid component capture liquid is circulated from the acid component capture liquid storage tank to the acid component capture liquid storage tank via the electrodialysis unit, the amine separation unit, and the acid component separation unit.

9. A CO₂ absorbent purification unit comprising:
an electrodialysis unit which includes, between a pair of electrodes facing each other, a desalination chamber, a concentration chamber, and a membrane disposed between the desalination chamber and the concentration chamber and selected from a cation exchange membrane, an anion exchange membrane, or a bipolar membrane and purifies the CO₂ absorbent by eluting the acid component from the CO₂ absorbent introduced into the desalination chamber and including the acid component to an acid component capture liquid introduced into the concentration chamber; and
an amine separation unit which separates an amine-based compound included in the acid component capture liquid; and
an acid component separation unit which separates an acid component included in the acid component capture liquid,
wherein the electrodialysis unit, the amine separation unit, and the acid component separation unit are coupled so that the acid component capture liquid can circulate.

10. A CO₂ gas removal method in which a gas to be treated containing a CO₂ gas is brought into contact with a CO₂ absorbent containing an amine-based compound to absorb the CO₂ gas, the CO₂ gas is recovered from the CO₂ absorbent which absorbed the CO₂ gas, the CO₂ absorbent is regenerated, and the regenerated CO₂ absorbent is reused as the CO₂ absorbent, the method comprising:
purifying the CO₂ absorbent by moving an acid component to an acid component capture liquid by electrodialysis;
separating an amine-based compound included in the acid component capture liquid; and
separating an acid component included in the acid component capture liquid.
